(19) United States
(12) Patent Application Publication
(10) Pub. No.: US 2015/0106697 A1
(43) Pub. Date: Apr. 16, 2015

(54) METHOD AND ELECTRONIC DEVICE FOR PROCESSING E-BOOK DOCUMENT

(71) Applicant: Xiaomi Inc., Beijing (CN)

(72) Inventors: Jiafang Zhang, Beijing (CN); Lei Zhang, Beijing (CN)

(73) Assignee: Xiaomi Inc.

(21) Appl. No.: 14/471,702

(22) Filed: Aug. 28, 2014

Related U.S. Application Data
(63) Continuation of application No. PCT/CN2014/077413, filed on May 14, 2014.

(30) Foreign Application Priority Data
Oct. 16, 2013 (CN) 2013310485775.8

(51) Int. Cl. G06F 17/21

(52) U.S. Cl. CPC G06F 17/212
USPC 715/243

(57) ABSTRACT

A method for processing an e-book document, includes: obtaining an e-book document; dividing content of the e-book document into a plurality of segments in accordance with a preset segmentation manner; composing the plurality of segments into an ordered segment group; selecting one segment from the segment group as a current segment; parsing the content of the current segment to generate layout data; and generating a page image in accordance with the layout data.

This application is a continuation of International Application No. PCT/CN2014/077413, filed May 14, 2014, which is based upon and claims priority to Chinese Patent Application No. 2013310485775.8, filed Oct. 16, 2013, the entire contents of all of which are incorporated herein by reference.

### TECHNICAL FIELD

The present disclosure generally relates to the field of data processing and, more particularly, to a method and an electronic device for processing an e-book document.

### BACKGROUND

With the growing popularity of mobile terminals, reading and editing e-books on mobile terminals is also becoming increasingly popular. In some cases, e-books have replaced paper books and become primary daily reading tools. Mobile terminals for reading e-books are versatile, such as smart phones, tablets or e-readers.

Conventionally, e-book documents are edited mainly by using hypertext markup language (HTML), and e-book documents edited by using HTML can be referred to as HTML documents. After a user opens an e-book via a mobile terminal, the mobile terminal reads the HTML document of the e-book into a memory, and converts the e-book into page images that can be viewed by the user through the mobile terminal by interpreting the HTML document. The interpreting process mainly includes a parsing step, a full paging step, a page object generating step, and a page image generating step, etc.

Generally, storage and computing abilities of a mobile terminal are limited compared to a fully capable computer. If an e-book has a relatively large size, data processed in reading the e-book by the mobile terminal may occupy a lot of storage resources, thus causing operation efficiency of the parsing step and the full paging step to decrease when reading the e-book document, and prolonging the time for the mobile terminal to read the e-book. Moreover, the larger the e-book size is, the more memory resources consumed in the parsing step and the full paging step are, such that the operation efficiency of the mobile terminal decreases. In a severe situation, the mobile terminal may not display the e-book smoothly or even crash.

### SUMMARY

According to a first aspect of the present disclosure, there is provided a method for processing an e-book document, comprising: obtaining an e-book document; dividing content of the e-book document into a plurality of segments in accordance with a preset segmentation manner; composing the plurality of segments into an ordered segment group; selecting one segment from the segment group as a current segment; parsing the content of the current segment to generate layout data; and generating a page image in accordance with the layout data.

According to a second aspect of the present disclosure, there is provided an electronic device, comprising: a processor; and a memory for storing instructions executable by the processor; wherein the processor is configured to: obtain an e-book document; divide content of the e-book document into a plurality of segments in accordance with a preset segmentation manner; compose the plurality of segments into an ordered segment group; select one segment from the segment group as a current segment; parse the content of the current segment to generate layout data; and generate a page image in accordance with the layout data.

According to a third aspect of the present disclosure, there is provided a non-transitory readable storage medium including instructions that, when executed by a processor of a terminal, cause the terminal to perform a method for processing an e-book document, the method comprising: obtaining an e-book document; dividing content of the e-book document into a plurality of segments in accordance with a preset segmentation manner; composing the plurality of segments into an ordered segment group; selecting one segment from the segment group as a current segment; parsing the content of the current segment to generate layout data; and generating a page image in accordance with the layout data.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart of a method for processing an e-book document, according to an exemplary embodiment.

FIG. 2 is a flowchart of a method for processing an e-book document, according to an exemplary embodiment.

FIG. 3 is a flowchart of a method for processing an e-book document, according to an exemplary embodiment.

FIG. 4 is a diagram of a method for processing an HTML document, according to an exemplary embodiment.

FIG. 5 is a block diagram of a terminal, according to an exemplary embodiment.

FIG. 6 is a block diagram of a segmentation module, according to an exemplary embodiment.

FIG. 7 is a block diagram of a terminal, according to an exemplary embodiment.

FIG. 8 is a block diagram of a terminal, according to an exemplary embodiment.

FIG. 9 is a block diagram of a terminal, according to an exemplary embodiment.

FIG. 10 is a block diagram of an electronic device, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of devices and methods consistent with aspects related to the invention as recited in the appended claims.

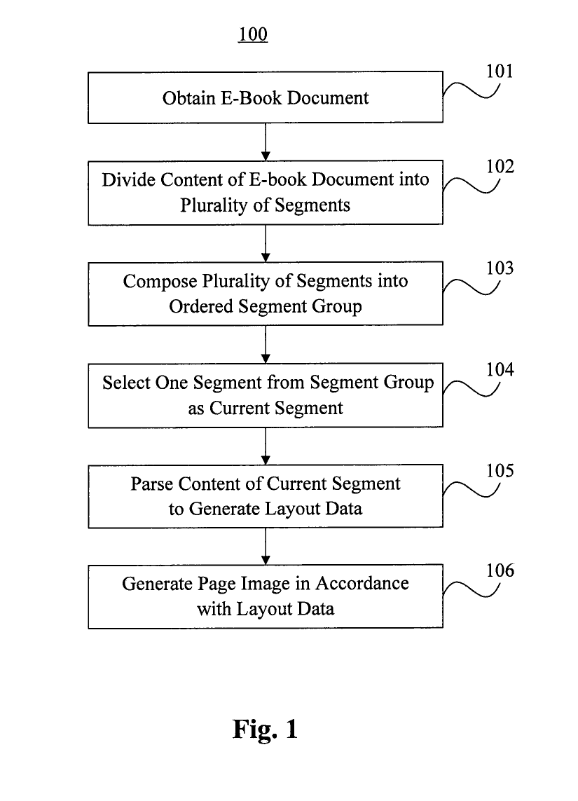

FIG. 1 is a flowchart of a method 100 for processing an e-book document for use in an electronic device, such as a mobile terminal, according to an exemplary embodiment. Referring to FIG. 1, the method 100 includes the following steps.

In step 101, the mobile terminal obtains an e-book document. For example, after a user opens an e-book on the mobile terminal, the mobile terminal reads the e-book document into an internal memory and, at this time, the mobile terminal obtains the e-book document.

In exemplary embodiments, the e-book document may be a streaming e-book document. The streaming e-book document is an e-book document in which information, such as characters and pictures, has no fixed layout position, and when layout parameters (such as a layout width, a font size and a line spacing) change, the layout needs to be rearranged to adapt the e-book document with new layout parameters. The streaming e-book document includes a document including, e.g., a hyper text markup language (HTML) document including labels. Accordingly, the mobile terminal may also obtain the labels constituting the HTML document while obtaining the HTML document of the e-book.

In step 102, the mobile terminal divides content of the e-book document into a plurality of segments in accordance with a preset segmentation manner. The preset segmentation manner may have many implementing forms, for example, by determining a segment size, and dividing the content of the e-book document into a plurality of segments having the same segment size. Specifically, the segment size represents the size of each segment after the e-book document is divided, and the segment size may be set in advance, or may be set by a user of the mobile terminal, or may be calculated according to experiments.

In step 103, the mobile terminal composes the plurality of segments into an ordered segment group. For example, to facilitate processing data according to an order of the content of the original e-book document, a connection between segments can be established by composing the segments into a segment group according to the original order.

In step 104, the mobile terminal selects one segment from the segment group as a current segment. For example, any segment in the segment group may be selected according to the user's requirements, for further processing.

In step 105, the content in the current segment is parsed to generate layout data. In the illustrated embodiment, the content in the current segment is a portion of the content of the whole e-book document, and the data that needs to be parsed is much less than the content of the whole e-book document. Accordingly, the parsing speed is improved. Moreover, since the data amount is reduced, the occupied memory of the mobile terminal is reduced.

In addition, after generating the layout data, in order to save the memory of the mobile terminal, the method 100 may include: judging whether layout atom data contained in the layout data is used within a preset time period and, if it is not used, deleting the layout atom data. For example, if the layout data is not used for a long time, in order to save the memory occupied by the layout data, the layout atom data may be deleted, which may be regenerated if needed later.

In addition, after generating the layout data, in order to save the memory of the mobile terminal, the method 100 may include: judging whether memory occupied by layout atom data contained in the layout data is greater than a preset value and, if it is greater than the preset value, deleting the layout atom data. For example, if the layout data has a large size such that the occupied memory is greater than the preset value, which may cause the processing speed to be slow, the whole layout data may be deleted, or a preset amount of the layout data may be deleted.

In step 106, the mobile terminal generates a page image in accordance with the layout data. Because the data amount of the layout data is generated by one segment, the data amount of the layout data is relatively small. Therefore, time for generating the page image and the occupied memory are both reduced.

In exemplary embodiments, step 106 further includes steps 1)-3): 1) performing a paging process to the layout data to generate a page layout frame; 2) generating a page object according to the page layout frame and the layout data; and 3) rendering the page object to generate the page image.

In the method 100, the e-book document is divided into a plurality of segments. Each time when an operation is performed on the e-book, one selected current segment of the e-book document is parsed, and the layout data generated from the current segment is used to generate the page image. Therefore, the data amount to be processed during operation each time is the data amount of one segment. In this way, when the mobile terminal reads the e-book document, the data processing efficiency may be raised, thereby shortening the time to read the e-book. Moreover, the segmentation operation may have the e-book document to be processed in batches, and when the mobile terminal processes one segment of the e-book document, regardless of the parsing operation or the subsequent page image generation operation, the data amount to be processed is relatively small, thus reducing the memory of the mobile terminal occupied by the e-book.

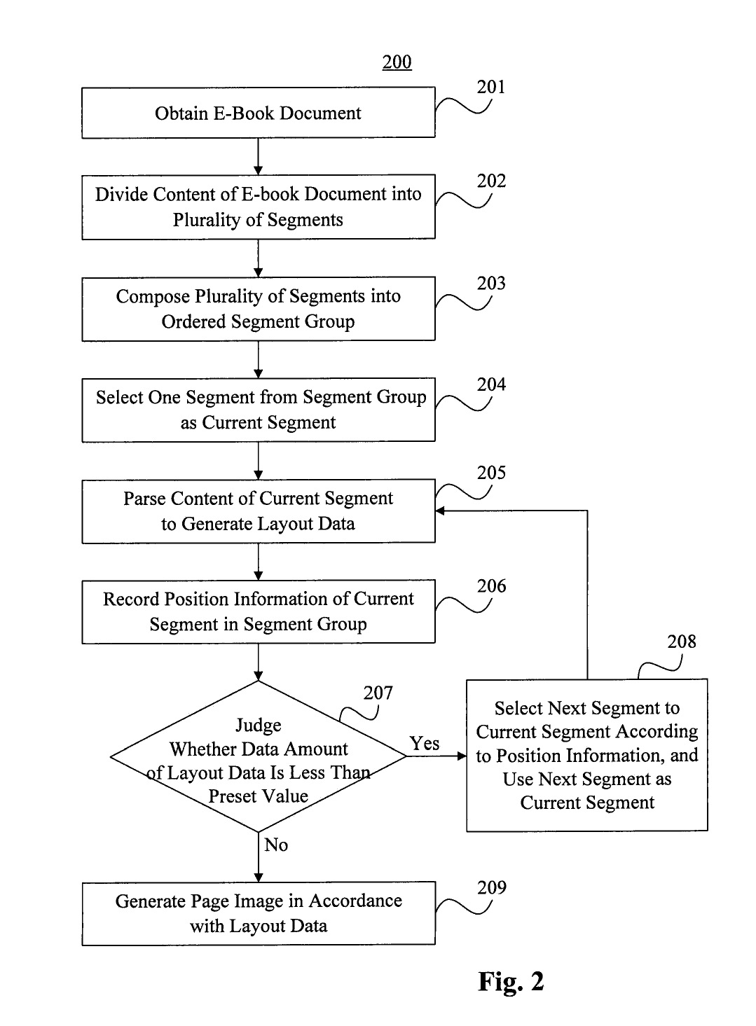

FIG. 2 is a flowchart of a method 200 for processing an e-book document for use in an electronic device, such as a mobile terminal, according to an exemplary embodiment. Referring to FIG. 2, the method 200 includes the following steps.

In step 201, the mobile terminal obtains an e-book document. For example, after a user opens an e-book on the mobile terminal, the mobile terminal reads the e-book document into an internal memory and, at this time, the mobile terminal obtains the e-book document. In exemplary embodiments, the e-book document may be an HTML document including labels. Accordingly, the mobile terminal may also obtain the labels of the HTML document while obtaining the HTML document of the e-book.

In step 202, the mobile terminal divides content of the e-book document into a plurality of segments in accordance with a preset segmentation manner. The preset segmentation manner may have many implementing forms. For example, a segmentation method may include determining a segment size, and dividing the content of the e-book document into a plurality of segments having the same segment size. Specifically, the segment size represents the size of each segment after the e-book document is divided, and the segment size may be set in advance, or may be set by a user of the mobile terminal, or may be calculated according to experiments.

In step 203, the mobile terminal composes the plurality of segments into an ordered segment group. For example, to facilitate processing data according to an order of the content of the original e-book document, a connection between segments can be established, by composing the segments into a segment group according to the original order.

In step 204, the mobile terminal selects one segment from the segment group as a current segment. For example, any segment in the segment group may be selected according to the user's requirements, for further processing.

In step 205, the content in the current segment is parsed to generate layout data. In the illustrated embodiment, the content in the current segment is a portion of the content of the whole e-book document, and the data that needs to be parsed is much less than the content of the whole e-book document. Accordingly, the parsing speed is improved. Moreover, since the data amount is reduced, the occupied memory is reduced.

In step 206, the mobile terminal records position information of the current segment in the segment group. For example, the mobile terminal can use bytes to record the position information, or use a mark to record the position information. For the e-book document being an HTML document, the position information of the segment may be recorded by using a byte offset. The unit of the byte offset is byte. The present disclosure is not limited thereto and, as long as a method can record a position of the segment in the segment group, that method is within the scope of the present disclosure.

In step 207, the mobile terminal judges whether a data amount of the layout data is less than a preset value. If the data amount of the layout data is less than the preset value, step 208 is performed; otherwise, step 209 is performed.

In the illustrated embodiment, the layout data is generated by parsing the current segment, and the data amount of the layout data generated by parsing each segment is a certain amount. If the data amount of the generated layout data is sufficient for generating a page image, then the layout data is used to generate a page image. If the data amount of the generated layout data is not sufficient for generating a page image, it is needed to parse a next segment to generate the layout data, and combine the existing layout data and the layout data generated from the next segment together to generate the page image.

In step 208, the mobile terminal selects a next segment to the current segment according to the position information. The next segment is used as the current segment, and the procedure returns to step 205. For example, in step 206, the position information of the current segment has been recorded and, thus, position information of the next segment is determined based on the position information of the current segment.

In step 209, the mobile terminal generates a page image in accordance with the layout data.

In the method 200, the data amount of the layout data is generated from one segment, and the data amount of the layout data is relatively small. Therefore, time for generating the page image and the occupied memory are both reduced.

In exemplary embodiments, after generating the plurality of segments, the mobile terminal can determine a start point and an end point of a segment. For example, when the e-book document is an HTML document, the start point of the segment is a start position of the segment, and the end point of the segment is an end position of the segment. The HTML document includes labels. A label can consist of two angle brackets, namely, a left angle bracket “<” and a right angle brackets “>,” with content of the label interposed between the two angle brackets. According to syntax provisions of HTML, a complete label includes the left angle bracket “<” and the right angle bracket “>.” Therefore, in some embodiments, after the segmentation, an irregular situation that a certain segment only contains a left angle bracket or only contains a right angle bracket is not allowed. If this happens, it means that a label is divided into two segments, so that it may not be possible to subsequently parse the label.

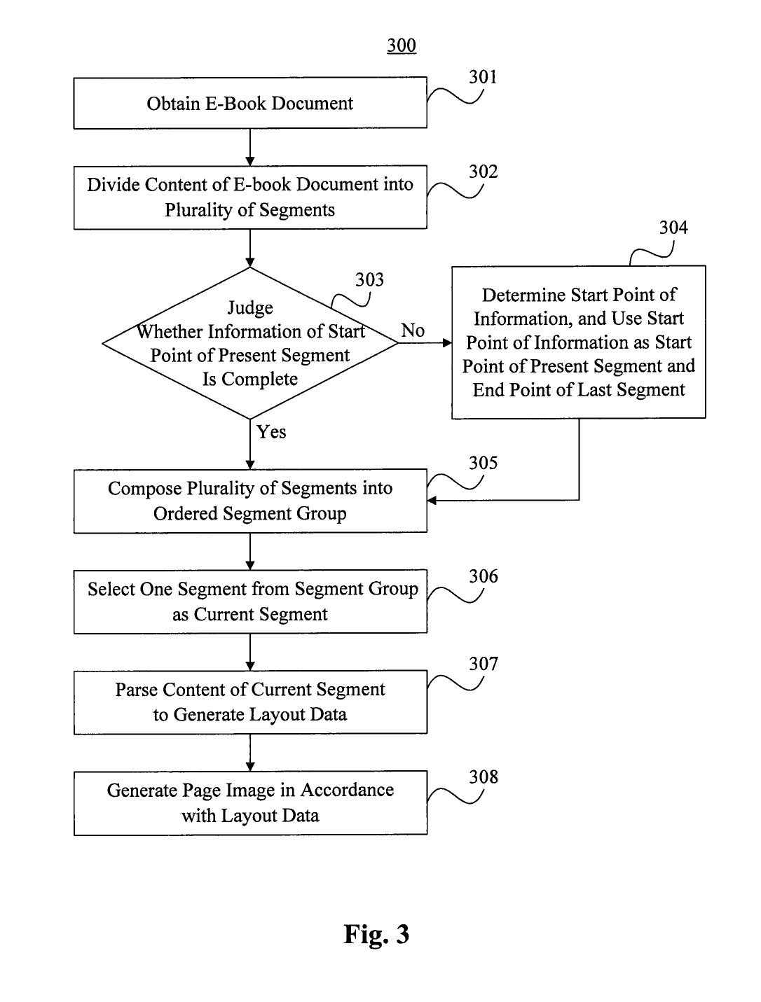

FIG. 3 is a flowchart of a method 300 for processing an e-book document for use in an electronic device, such as a mobile terminal, according to an exemplary embodiment. Referring to FIG. 3, the method 300 includes the following steps.

In step 301, the mobile terminal obtains an e-book document. For example, after a user opens an e-book on the mobile terminal, the mobile terminal reads the e-book document into an internal memory and, at this time, the mobile terminal obtains the e-book document. In exemplary embodiments, the e-book document may be an HTML document including labels. Accordingly, the mobile terminal may also obtain the labels of the HTML document while obtaining the HTML document of the e-book.

In step 302, the mobile terminal divides content of the e-book document into a plurality of segments in accordance with a preset segmentation manner. The preset segmentation manner may have many implementing forms. For example, a segmentation method may include determining a segment size, and dividing the content of the e-book document into a plurality of segments having the same segment size. Specifically, the segment size represents the size of each segment after the e-book document is divided, and the segment size may be set in advance, or may be set by a user of the mobile terminal, or may be calculated according to experiments.

In step 303, the mobile terminal judges whether information of a start point of a present segment is complete. If the information of the start point of the present segment is complete, step 305 is performed; otherwise, step 304 is performed.

For example, after the segmentation, in order to avoid one piece of complete information from being divided into two segments, the mobile terminal determines whether the information of the start point of the segment is complete and, if it is not complete, the mobile terminal can make an adjustment to the start point and an end point of the segment, so that the information in each segment is complete.

In step 304, the mobile terminal determines a start point of the information by moving the start point of the segment toward a last segment, and the start point of the information is used as the start point of the present segment and the end point of the last segment.

For example, if the information of the start point of the present segment is not complete, it means that a first portion of the information is assigned into the last segment, while a second portion of the information stays at the start point of the segment. In one exemplary embodiment, the mobile terminal deletes the first portion of the information in the last segment, and supplements the first portion of the information to the start point of the present segment, wherein the start point of the present segment and the end point of the last segment are the same point. In another exemplary embodiment, the mobile terminal moves the start point of the present segment toward the end point of the present segment to determine an end point of the information, and uses the end point of the information as the start point of the present segment and the end point of the last segment. In this embodiment, the second portion of the information is deleted from the present segment, and supplemented to the end point of the last segment.

In exemplary embodiments, other than performing step 304, the mobile terminal can determine a start point of other information as the start point of the present segment and the end point of the last segment. The present disclosure is not limited to the manner of step 304. Other methods, as long as being capable of achieving the purpose of complete information, may be also applicable, which are not limited herein.

In step 305, the mobile terminal composes the plurality of segments into an ordered segment group. For example, to facilitate processing data according to an order of the content of the original e-book document, a connection between segments can be established, by composing the segments into a segment group according to the original order.

In step 306, the mobile terminal selects one segment from the segment group as a current segment. For example, any segment in the segment group may be selected according to the user's requirements, for further processing.

In step 307, the content in the current segment is parsed to generate layout data. In the illustrated embodiment, the content in the current segment is a portion of the content of the whole e-book document, and the data that needs to be parsed is much less than the content of the whole e-book documents. Accordingly, the parsing speed is improved. Moreover, since the data amount is reduced, the occupied memory is reduced.

In step 308, the mobile terminal generates a page image in accordance with the layout data. Because the data amount of the layout data is generated by one segment, the data amount of the layout data is relatively small. Therefore, time for generating the page image and the occupied memory are both reduced.

In exemplary embodiments, in order to avoid one piece of complete information from being divided into two segments, the mobile terminal can also determine whether information of the end point of the segment is complete. In one exemplary embodiment, the mobile terminal determines whether the information of the end point of the segment is complete and, if it is not complete, moves the end point of the present segment to a next segment to determine an end point of the information. The mobile terminal further uses the end point of the information as the end point of the segment and the start point of the next segment. In another exemplary embodiment, the mobile terminal determines whether the information of the end point of the segment is complete and, if it is not complete, moves the end point of the segment toward the start point of the segment to determine a start point of the information. The mobile terminal further uses the start point of the information as the end point of the segment and the start point of the next segment.

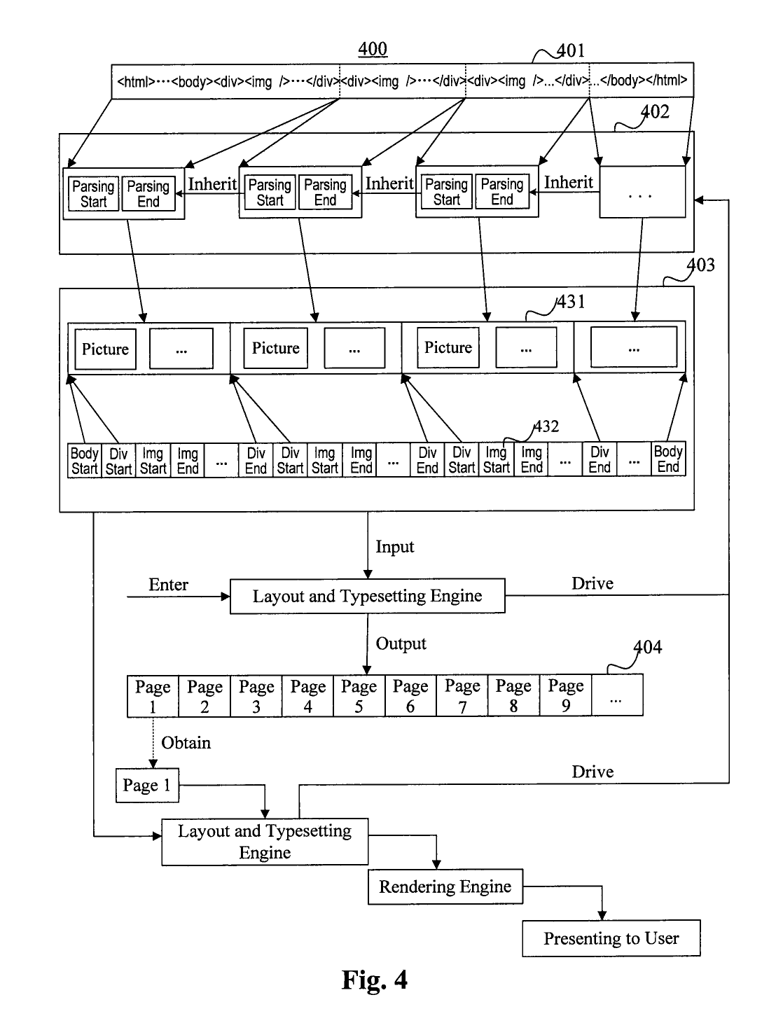

FIG. 4 is a diagram of a method 400 for processing an e-book document, according to an exemplary embodiment. In the illustrated embodiment, the e-book document is an HTML document. Referring to FIG. 4, the method 400 includes the following steps.

In a first step, an HTML document 401 is obtained.

In a second step, content of the HTML document 401 is divided into a plurality of HTML segments according to a preset segmentation manner.

In the second step, the HTML document 401 is parsed through parsing each HTML segment, and time spent in parsing an HTML segment is acceptable. If only one HTML segment is processed during each parsing process, a single parsing time may be shortened. Therefore, the HTML document 401 is parsed through parsing each HTML segment.

In one exemplary embodiment, a size of m bytes is determined for each segment, and a size of the HTML document 401 is n bytes. The HTML document 401 can be divided into n/m segments according to the value m, thus obtaining (n/m−1) breakpoints. Since completeness of the labels in the HTML document 401 is needed when parsing the HTML document 401 from a non-starting point, so as to prevent, e.g., a half label from appearing in an HTML segment, it is examined whether every breakpoint of the (n/m−1) breakpoints satisfies the requirement of not being within a HTML label. According to syntax provisions of HTML, an HTML label needs to be bracketed by a left angle bracket “<” and a right angle bracket “>”, with a length generally within 1024 bytes. Based on the syntax provisions, a certain number of bytes before and after each breakpoint in the (n/m−1) breakpoints can be checked to satisfy the requirement of the breakpoint not being within the HTML label.

In exemplary embodiments, the size value m of the segment can be preset, or determined by calculation, as described below.

Since a parsing time of the HTML document 401 is decided directly by a number of HTML nodes, as a size of the HTML document 401 increases, the number of the HTML nodes also increases, and the time for deeply traversing the HTML nodes also increases. Therefore, a curve of the parsing time of the HTML document 401 varying with the size of the HTML document 401 is a forward increasing curve. Generally, when the size of the HTML document 401 is small, the number of the HTML nodes is also small. The parsing of the HTML document 401 can realize a deep traversal in a short time. For example, for the HTML document 401 having a 10K size and a 50K size, the parsing times of both may have little difference. When the size of the HTML document 401 reaches a certain level, the number of the HTML nodes may have a non-linear dramatic increase, thereby causing the parsing time of the HTML document 401 to increase non-linearly. Accordingly, the parsing time of the HTML document 401 varies with the size of the HTML document 401 first relatively smoothly and then relatively sharply. Thus, theoretically, there is an inflection point in the curve. When the size of the HTML document 401 reaches the inflection point, parsing efficiency of the HTML document 401 declines relatively sharply.

A parsing performance test can be performed to the HTML document 401. A curve of the parsing time of the HTML document 401 varying with the size of the HTML document 401 can be plotted by using a visualization tool, thus to verify the above theoretical analysis.

Through the curve of the parsing time of the HTML document 401 varying with the size of the HTML document 401 after the above theoretical verification, it can be determined that when the size of the HTML document 401 is smaller than a certain value M, the parsing time of the HTML document 401 can have little variation, while when the size of the HTML document 401 is greater than a certain value N, the parsing time of the HTML document 401 may increase sharply. Accordingly, the size of the HTML document 401 corresponding to the inflection point of the parsing performance may be determined within an interval [M, N]. Then, an analysis within the interval is performed. There are two criteria that can be considered when performing the analysis: a) it may be inappropriate to divide the HTML document 401 into too many segments, otherwise the complexity of segment management may increase, i.e., the size value m of each segment may not be too small; and b) it may be inappropriate that the parsing time for a single HTML segment is too long, otherwise there may be disadvantages such as the user waits too long, i.e., the size value m of each segment may not be too large. The minimum value M and the maximum value N in the interval [M, N] may be removed according to the above two criteria to obtain a new interval, then a minimum value and a maximum value in the new interval may be removed again according to the above two criteria. By repeating the above operation, if there is one value remaining finally, this value can be used as the size of the HTML document 401 corresponding to the performance inflection point (i.e., the size value m of the segment). If there are two values remaining finally, then a middle value between the two values is used as the size of the HTML document 401 corresponding to the performance inflection point (i.e., the size value m of the segment).

In a third step, the plurality of segments are composed into an ordered segment group.

When a parsing starts from a non-starting point of the HTML document 401, the HTML document 401 may have incomplete context, which may cause problems such as losing label nodes. Therefore, in the illustrated embodiment, a parsing state interval 402 of the HTML document 401 is used to overcome the problem, as follows.

First, a parser for the HTML document 401 is newly generated. A state of the parser is the HTML document 401 having not been parsed, which is referred to herein as the initial parsing state. The initial parsing state is not relevant to the specific HTML document 401, and any newly generated parser for the HTML document 401 may be in the initial parsing state.

Second, since the parsing state of the HTML document 401 may record a byte offset in the HTML document 401, the segmentation result of the HTML document 401 is also specified by using the byte offset. Accordingly, a one-to-one correspondence between the HTML segment and the parsing interval may be established according to the corresponding relationship of the byte offset. Therefore, the first HTML segment corresponds to the first parsing interval, a parsing start state of the first parsing interval is the initial parsing state (the byte offset is where the first segment starts), and a parsing end state of the first parsing interval is a state after the parsing of the first HTML segment is complete (the byte offset is where the first segment ends).

Third, for the parsing interval corresponding to each HTML segment following the first HTML segment, a parsing start state thereof inherits the parsing end state of the last parsing interval, and a parsing end state thereof is a state after the parsing of this HTML segment is complete. The inheriting of the parsing state is a cloning process of the parsing state, namely, copying intactly the byte offset of the HTML document 401 where one parsing state locates (for recording a current position of the parsing state in the HTML document 401), stack information of a father HTML label node (for recording a path that the parsing state passes in the HTML document 401), and a context relationship when parsing (for recording a context relationship that the parsing state within the text nodes of the HTML document 401) and the like into another parsing state.

According to this scheme, each HTML segment, when taking part in the parsing process of the HTML document 401, inherits the parsing state of the last HTML segment, i.e., inherits the context relationship of the last HTML segment, thereby the problem caused by the incomplete context relationship is overcome.

In a fourth step, one segment is selected from the segment group as a current segment.

In a fifth step, content of the current segment is parsed to generate layout data 403. An exemplary layout driving process is provided as follows.

First, a layout and typesetting engine is started up. When layout atom data 431 corresponding to the current HTML segment is found as null, a search is performed to identify an HTML segment where a point in the current layout locates according to the offset of the HTML document 401 corresponding to the point, a parsing interval of the corresponding HTML document 401 is awaked, and the corresponding HTML segment is interpreted, thus generating corresponding label node data 432 and layout atom data 431. For the label node data 432, since the layout atom data 431 depends on fashion information of the label node data 432, with the parsing of the layout atom data 431, the label node data 432 is also parsed accordingly. One copy of the label node data 432 may be saved, and if it is found that the label node data 432 corresponding to the HTML segment already exists, no corresponding label node data 432 is added into the parsing process.

Second, the layout is performed to complete paging or the page object generation. Meanwhile, a usage of current storage resources is monitored, and if the usage is greater than a specified threshold value (for example, an application of an Android platform is generally limited within 24 MB, and an application of an iOS platform is generally limited within 20 MB), the layout atom data 431 corresponding to a temporarily unused HTML segment is deleted.

In a sixth step, a page image is generated according to the layout data 403. An exemplary full HTML paging process is provided as follows.

The full HTML paging process is performed by calling the layout driving process for each HTML segment sequentially. For each HTML segment, when the paging process reaches a last page of the segment, a case of half a page may occur. In order to ensure that the last page of the current segment is consecutive with the next segment, HTML data of the next segment is also parsed, then paging is performed from the start point of the last page of the current segment. If the layout atom is found to be inadequate, then the layout atom of the next segment is used to avoid non-consecutive segments.

An exemplary page object generating process is provided as follows.

First, through the byte offset of the HTML document 401, also referred to herein as a request point, the page number in a page space 404 corresponding thereto is determined (the start point and the end point of the HTML page may record the byte offset in the HTML document 401). In exemplary embodiments, the page number may be obtained or may not be obtained. If the page number is obtained, it indicates that the full paging process has reached the request point, then the full paging result corresponding to the page number is used. If the page number is not obtained, it indicates that the full paging process does not reach the request point, and a temporary parsing process is started up to obtain the paging result corresponding to the request point.

Second, according to the obtained paging result, a layout driving process is called, and the page object generation is complete.

An exemplary temporary parsing process is provided as follows.

First, the HTML segment where the request point locates, also referred to herein as the request segment, is determined according to the request point. Further, the parsing state interval 402 of the HTML document 401 is newly generated, the parsing start state thereof is the initial parsing state, and the parsing end state is a state of the request segment after being parsed by using the parsing start state.

Second, the layout driving process is called, the above parsing state interval 402 is forced to perform paging for the request segment, and the page space 404 for temporary parsing is generated.

Third, a page number of the request point in the page space 404 for temporary parsing is determined according to the request point, and the temporary parsing page result is obtained according to the page number.

In exemplary embodiments, when the full paging process does not yet reach an interval where the requested page locates, the temporary parsing process is used to obtain the requested page. Although the complete HTML context relationship is not used, after the full paging process reaches the requested page, it turns to the full paging result to correct any problem of parsing the HTML from the non-starting point. When the HTML full paging process is not yet complete, no jump may be allowed to the next page by using the page number, because the page number may exceed the number that the full paging process has paged. A page jump may be performed according to a percentage of the HTML document size. After the full paging process is complete, a page jump can be performed by using the page number.

The method 400 makes the HTML document 401 having a large size occupy a relatively small memory space during the full paging process, and reduces the obtaining time of the full paging result in the front part of the HTML document 401. In addition, a temporary parsing is used prior to the full paging, thereby the HTML jumping performance is improved, and problems likely existing in the temporary parsing are corrected after the full paging.

The method 400 may bring the following beneficial effects for user experiences:

1. The parsing time and the full paging time of the HTML document 401 are apportioned to each HTML segment, and the waiting time of the first page is shortened when the user opens the HTML document 401 having a large size;

2. After the full paging reaches the request point, the full paging result is used, so as to ensure that the book fashion structure is not ruined when the user reads the HTML document 401 having a large size, and the content is presented to the user in a form most respecting the original book;

3. A smaller memory space is occupied, thus a crash probability when the user opens the HTML document 401 having a large size on an apparatus having a small storage, such as a mobile device, is reduced;

4. A smaller memory space is occupied, thus reading software operates more fluently when the user reads the HTML document 401 having a large size, and the fluency of user operation is improved;

5. The temporary parsing process is adopted, thus the waiting time for synchronizing a reading progress is shortened when the user reads the HTML document 401 having a large size;

6. The temporary parsing process is adopted, thus the waiting time for the catalog jumping is shortened when the user reads the HTML document 401 having a large size;

7. The temporary parsing process is adopted, thus the waiting time for fast advancing or fast rewinding is shortened when the user reads the HTML document 401 having a large size.

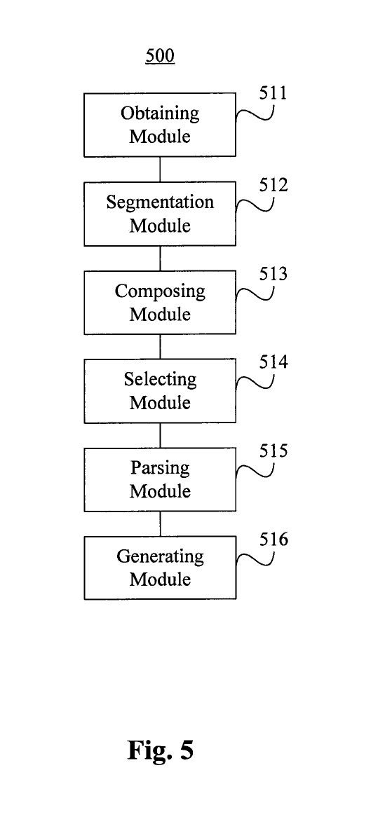

FIG. 5 is a block diagram of a terminal 500 for processing an e-book document, according to an exemplary embodiment. Referring to FIG. 5, the terminal 500 includes an obtaining module 511 configured to obtain an e-book document; a segmentation module 512 configured to divide content of the e-book document into a plurality of segments in accordance with a preset segmentation manner; a composing module 513 configured to compose the plurality of segments into an ordered segment group; a selecting module 514 configured to select a segment from the segment group as a current segment; a parsing module 515 configured to parse the content of the current segment to generate layout data; and a generating module 516 configured to generate a page image in accordance with the layout data.

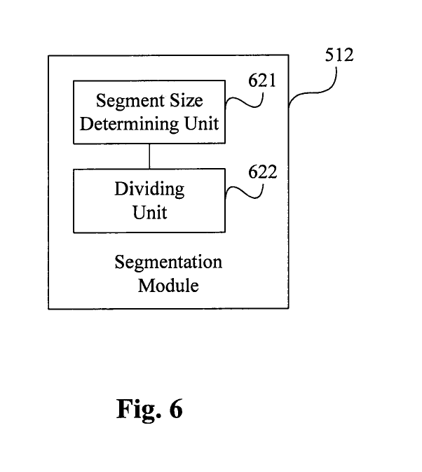

FIG. 6 is a block diagram of the segmentation module 512 (FIG. 5), according to an exemplary embodiment. Referring to FIG. 6, the segmentation module 512 includes a segment size determining unit 621 and a dividing unit 622, wherein the segment size determining unit 621 is configured to determine a segment size; and the dividing unit 622 is configured to divide the content of the e-book document into the plurality of segments having the same segment size.

Referring back to FIG. 5, the segmentation module 512 is configured to divide the e-book document into the plurality of segments. Each time when performing an operation on an e-book, the parsing module 515 parses one segment of the e-book document, and the generating module 516 generates the page image by using the layout data generated from the segment. Therefore, a data amount to be processed during operation each time is only the data amount of one segment. In this way, when the mobile terminal reads the e-book document, the data processing efficiency may be raised, thereby shortening the time to read the e-book. Moreover, the segmentation operation may have the e-book document to be processed in batches, and when the mobile terminal processes one segment of the e-book document, the data amount to be processed in the parsing operation or in the subsequent page image generation operation is relatively small, thus reducing the memory space of the mobile terminal occupied by the e-book.

Referring to FIG. 6, the segment size obtained by the segment size determining unit 621 is used to represent the size of each segment after the e-book document is divided. The segment size may be set in advance, or may be set by a user of the mobile terminal, or may be calculated according to experiments. Then, the dividing unit 622 is used to divide the e-book document according to the obtained segment size.

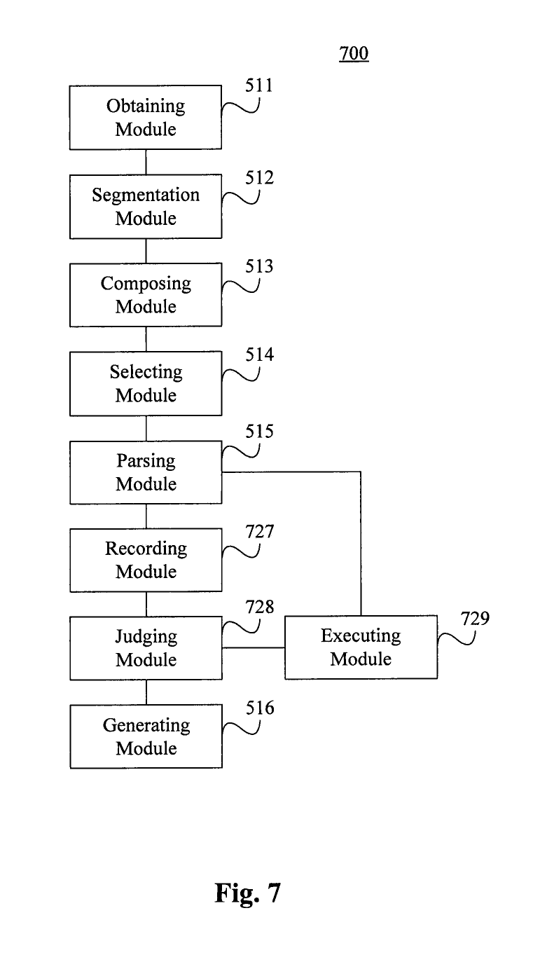

FIG. 7 is a block diagram of a terminal 700, according to an exemplary embodiment. Referring to FIG. 7, the terminal 700 includes: a recording module 727 configured to recording position information of the current segment in the segment group; a judging module 728 configured to judge whether a data amount of the layout data is less than a preset value; and an executing module 729 configured to, when the data amount is less than the preset value, select a next segment to the current segment according to the position information as the current segment, and then instruct the parsing module 515 to repeat its operation, in addition to the modules of the terminal 500 (FIG. 5).

In the illustrated embodiment, whether the data amount of the generated layout data is sufficient to generate the page image is judged by the judging module 728. If sufficient, the page image is generated according to the existing layout data; otherwise, the next segment is parsed, and the existing layout data and the layout data generated by the next segment are combined together to generate the page image.

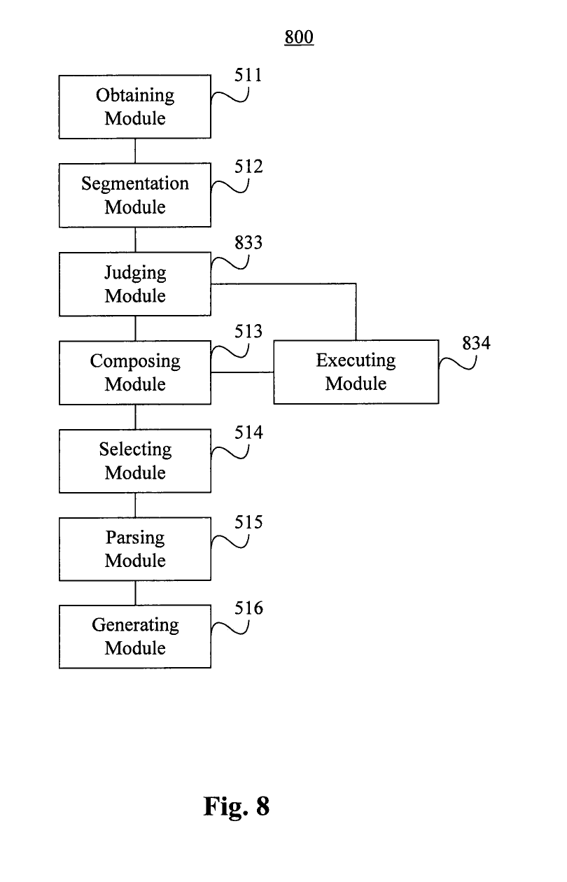

FIG. 8 is block diagram of a terminal 800, according to an exemplary embodiment. Referring to FIG. 8, the terminal 800 includes a judging module 833 configured to judge whether information of a start point of a present segment is complete; and an executing module 834 configured to move the start point of the present segment to determine a start point of a label when the information of the start point of the present segment is not complete, and use the start point of the label as the start point of the present segment, in addition to the modules of the terminal 500 (FIG. 5).

In the illustrated embodiment, in order to avoid one piece of complete information from being divided into two segments, the start point and the end point of the segment are further adjusted, similar to the above description in connection with FIG. 3.

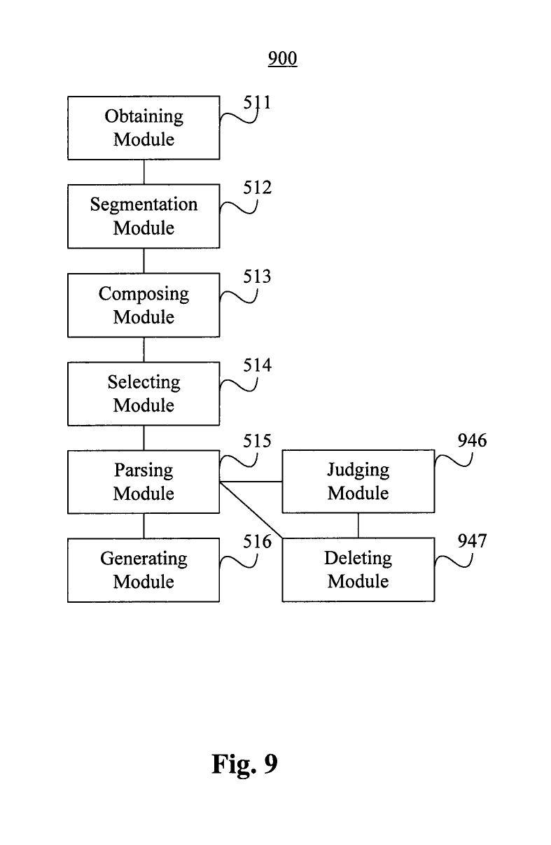

FIG. 9 is a block diagram of a terminal 900, according to an exemplary embodiment. Referring to FIG. 9, the terminal 900 includes a judging module 946 configured to judge whether layout atom data contained in the layout data is used within a preset time period, and a deleting module 947 configured to delete the layout atom data when the layout atom data is not used within the preset time period, in addition to the modules of the terminal 500 (FIG. 5).

In the illustrated embodiment, after the parsing module 515 generates the layout data, in order to save the memory of the mobile terminal, the judging module 946 and the deleting module 947 are used. If the layout data is not used within the preset time period, in order to save the memory occupied by the layout data, the layout atom data may be deleted, and may be regenerated later if needed, similar to the above description in connection with FIG. 1.

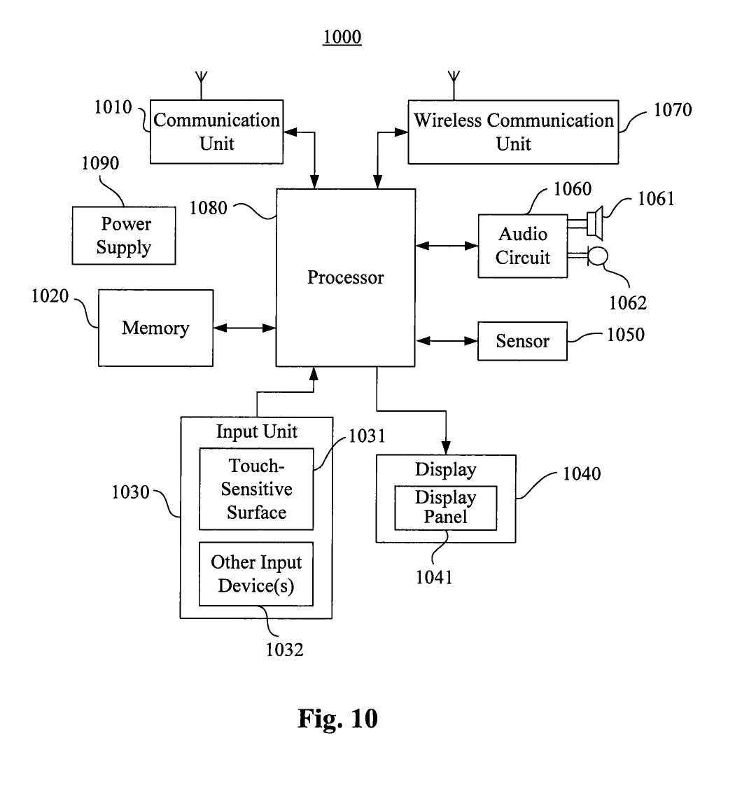

FIG. 10 is a block diagram of an electronic device, such as a terminal 1000, for processing an e-book document, according to an exemplary embodiment. Referring to FIG. 10, the terminal 1000 may include one or more of a communication unit 1010, memory resources represented by a memory 1020, an input unit 1030, a display 1040, a sensor 1050, an audio circuit 1060, a wireless communication unit 1070, a processor 1080 including one or more process cores, a power supply 1090 and the like. Those skilled in the present art will understand that the terminal 1000 is not limited to the structure shown in FIG. 10, and the terminal 1000 may include more or less components, or a combination of some components, or have different component arrangements.

The communication unit 1010 is configured to transmit and receive signals during transmitting and receiving of information or a process of calling. The communication unit 1010 may be a network communication device such as a radio frequency (RF) circuit, a router, a modem and the like. For example, if the communication unit 1010 is the RF circuit, the communication unit 1010 receives downlink information from a base station and then transmits the downlink information to the processor 1080 to be processed, and transmits the related uplink data to the base station. Generally, the RF circuit as the communication unit 1010 includes, but is not limited to, an antenna, at least one amplifier, a tuner, one or more oscillators, a subscriber identity module (SIM) card, a transceiver, a coupler, a low noise amplifier (LNA), a duplexer and the like. Additionally, the communication unit 1010 may also communicate with a network or other devices via a wireless network. The wireless network may adopt any communication standard or protocol including, but not limited to, global system of mobile communication (GSM), general packet radio service (GPRS), code division multiple access (CDMA), wideband code division multiple access (WCDMA), long term evolution (LTE), email, short messaging service (SMS) and the like.

The memory 1020 is configured to store programs and modules software programs and modules, which allow various types of functional applications and data processes to be performed when executed by the processor 1080. The memory 1020 may mainly include a program storage area and a data storage area. The program storage area may store an operating system, applications required by at least one required functions (such as a voice play function, an image play function and the like). The data storage area may store data (such as video data, phonebook data, and the like) created by the terminal 1000. In addition, the memory 1020 may include a high speed random access memory. The memory 1020 may also include a nonvolatile memory (NVM), such as at least a magnetic disk storage device, a flash memory or other nonvolatile solid-state storage devices. Correspondingly, the memory 1020 may also include a memory controller to control access to the memory 1020 performed by the processor 1080 and the input unit 1030.

The input unit 1030 is configured to receive input numerical or character information and generate signal inputs through a keypad, a mouse, an operation rod, optical or trackball related to user settings and function control. The input unit 1030 may include a touch sensitive surface 1031 and one or more other input devices 1032. The touch sensitive surface 1031, also called a touch display screen or a track pad, may collect a touch operation on it or near it by the user (for example, the user operations on or near the touch sensitive surface 1031 with any kind of suitable objects or attachments such as a finger, a touch pen, and the like), and drive a corresponding connected device according to a preset program. The touch sensitive surface 1031 may include first and second parts, i.e., a touch detecting device and a touch controller. The touch detecting device may detect the touch orientation of the user, and detect the signal caused by the touch operation, and then transmit the signal to the touch controller. The touch controller may receive the touch information from the touch detecting device and convert it into touch point coordinates and then transmit the coordinates to the processor 1080. The touch controller also receives and performs instructions from the processor 1080. Additionally, the touch sensitive surface 1031 may be realized in various types such as a resistive type, a capacitive type, an infrared type, or a surface acoustic wave type and the like. The input unit 1030 may also include one or more other input devices 1032. The other input devices 1032 may include, without limitation, one or more of a physical keypad, functional buttons (such as volume control button, switch button and the like), a trackball, a mouse, a joystick, and the like.

The display 1040 is configured to display various kinds of graphic user interfaces and information input by the user or provided to the user. These graphic user interfaces may be made up of graphics, texts, icons, videos and any other combination thereof. The display 1040 may include a display panel 1041 configured with a liquid crystal display (LCD), an organic light-emitting diode (OLED) or the like. Furthermore, the touch sensitive surface 1031 may be configured to cover the display panel 1041. When detecting the touch operation performed on or near the touch sensitive surface 1031, the touch sensitive surface 1031 may transmit signals to the processor 1080 to determine a type of the touch operation, and then the processor 1080 may provide a corresponding visual output on the display panel 1041 according to the type of the touch operation. Although in FIG. 10 the touch sensitive surface 1031 and the display panel 1041 are configured to realize the input and output functions as two independent components, they can be integrated together in some embodiments to realize the input and output functions.

The sensor 1050 may be a photo sensor, a motion sensor, or any other sensors. For example, the photo sensor may include an ambient light sensor and a proximity sensor. The ambient light sensor may adjust brightness of the display panel 1041 according to intensity of the ambient light. The proximity sensor may close the display panel and/or backlight when the terminal 1000 is close to the user's ear. As an example of the motion sensor, a gravitational acceleration sensor may detect values of accelerations in various directions (e.g., along three axes), may detect a value and a direction of the gravitation when being in stationary, and may be used in an application for identifying a terminal attitude (such as switching between a landscape mode and a vertical mode, corresponding games, magnetometer pose adjusting), functions related to vibration (such as a pedometer, knocking) and the like. Other sensors such as a gyroscope, a barometer, a hydrometer, a thermometer, an infrared sensor and the like which may be arranged in the terminal 1000 will not be described in detailed.

The audio circuit 1060 is coupled to a speaker 1061 and a microphone 1062, and may provide an audio interface between the user and the terminal 1000. The audio circuit 1060 may convert received audio data into electronic signals and transmit the electronic signals to the speaker 1061, and the speaker 1061 may convert the electronic signals into voice and output the voice. Additionally, the microphone 1062 may convert collected voice signals into electronic signals, and the audio circuit 1060 receives the electronic signals and converts them into audio data. The audio data is transmitted to the processor 1080 and then is transmitted to another terminal via the communication unit 1010 after processed by the processor 1080, or the audio data is transmitted to the memory 1020 to be further processed. The audio circuit 1060 may also include an earplug jack to allow communication between a peripheral earphone and the terminal 1000.

The wireless communication unit 1070 may be a WiFi module configured to provide wireless broadband internet access, which allows the user to transmit or receive E-mail, browse web pages and access streaming media and the like. Although the wireless communication unit 1070 is shown in FIG. 10, it should be understood that the wireless communication unit 1070 is not a necessary component of the terminal 1000, and may be omitted according to requirements.

The processor 1080 is a control center of the terminal 1000 that uses various interfaces and wires to connect respective components of the terminal 1000. By running or executing software programs and/or modules stored in the memory 1020, calling data stored in the memory 1020, and executing various functions of the terminal 1000 and processing data, the processor 1080 handles overall monitoring to the terminal 1000. The processor 1080 may include one or more processing cores, and may integrate an application processor and a modem processor. The application processor may mainly process the operation system, user interfaces, application programs and the like, and the modem processor may mainly process wireless communications. In some embodiments, the modem processor may not be integrated into the processor 1080.

The power supply 1090 is configured to supply power to respective components of the terminal 1000. The power supply 1090 may be logically connected with the processor 1080 through a power supply management system, thereby realizing functions of managing charging, discharging, power consumption, and through the power supply management system. The power supply 1090 may further include one or more of a direct current (DC) power supply or an alternating current (AC) power supply, a rechargeable system, a power supply malfunction detection circuit, a power supply converter or an inverter, a power supply state indicator and the like.

Although not shown, the terminal 1000 may also include a camera, a Bluetooth module, etc.

In exemplary embodiments, there is also provided a non-transitory storage medium including instructions, such as included in the memory 1020, executable by the processor 1080, for performing the above-described methods for processing an e-book document. For example, the readable storage medium may be a random access memory (RAM), a read only memory (ROM), an electrically programmable ROM, an electrically erasable programmable ROM, a registers, a hard disk, a removable disk, a CD-ROM, or any other storage medium in the technical field.

One of ordinary skill in the art will understand that the above described modules/units can each be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for processing an e-book document, comprising:
obtaining an e-book document;
dividing content of the e-book document into a plurality of segments in accordance with a preset segmentation manner;
composing the plurality of segments into an ordered segment group;
selecting one segment from the segment group as a current segment;
parsing the content of the current segment to generate layout data; and
generating a page image in accordance with the layout data.

2. The method according to claim 1, after the generating the layout data, further comprising:
recording position information of the current segment in the segment group; and
judging whether a data amount of the layout data is less than a preset value and, if the data amount is less than the preset value, selecting a next segment to the current segment according to the position information, using the next segment as the current segment, and repeating the parsing of the content of the current segment.

3. The method according to claim 1, wherein the dividing of the content of the e-book document into the plurality of segments in accordance with the preset segmentation manner comprises:
determining a segment size; and
dividing the content of the e-book document into the plurality of segments having the same segment size.

4. The method according to claim 1, further comprising:
judging whether information of a start point of a present segment is complete and, if the information is not complete, moving the start point of the present segment toward a last segment to determine a start point of the information, and using the start point of the information as the start point of the present segment and an end point of the last segment.

5. The method according to claim 1, further comprising:
judging whether information of a start point of a present segment is complete and, if the information is not complete, moving the start point of the present segment toward an end point of the present segment to determine an end point of the information, and using the end point of the information as the start point of the present segment and an end point of a last segment.

6. The method according to claim 1, further comprising:
judging whether information of an end point of a present segment is complete and, if the information is not complete, moving the end point of the present segment toward a next segment to determine an end point of the information, and using the end point of the information as the end point of the present segment and a start point of the next segment.

7. The method according to claim 1, further comprising:
judging whether information of an end point of a present segment is complete and, if the information is not complete, moving the end point of the present segment toward a start point of the present segment to determine a start point of the information, and using the start point of the information as the end point of the present segment and a start point of a next segment.

8. The method according to claim 1, further comprising:
judging whether layout atom data contained in the layout data is used within a preset time period and, if the layout atom data is not used within the preset time period, deleting the layout atom data.

9. The method according to claim 1, further comprising:
judging whether a memory space occupied by layout atom data contained in the layout data is greater than a preset value and, if the occupied memory space is greater than the preset value, deleting the layout atom data.

10. An electronic device, comprising:
a processor; and
a memory for storing instructions executable by the processor;
wherein the processor is configured to:
obtain an e-book document;
divide content of the e-book document into a plurality of segments in accordance with a preset segmentation manner;
compose the plurality of segments into an ordered segment group;
select one segment from the segment group as a current segment;
parse the content of the current segment to generate layout data; and
generate a page image in accordance with the layout data.

11. The electronic device according to claim 10, wherein the processor is further configured to:
record position information of the current segment in the segment group; and
judge whether a data amount of the layout data is less than a preset value and, if the data amount is less than the preset value, select a next segment to the current segment according to the position information, use the next segment as the current segment, and repeat parsing the content of the current segment.

12. The electronic device according to claim 10, wherein the processor is further configured to:
determining a segment size; and
divide the content of the e-book document into the plurality of segments having the same segment size.

13. The electronic device according to claim 10, wherein the processor is further configured to:
judge whether information of a start point of a present segment is complete and, if the information is not complete, move the start point of the present segment toward a last segment to determine a start point of the information, and use the start point of the information as the start point of the present segment and an end point of the last segment.

14. The electronic device according to claim 10, wherein the processor is further configured to:
judge whether information of a start point of a present segment is complete, and if the information is not complete, move the start point of the segment toward an end point of the present segment to determine an end point of the information, and using the end point of the information as the start point of the present segment and an end point of a last segment.

15. The electronic device according to claim 10, wherein the processor is further configured to:
judge whether information of an end point of a present segment is complete and, if the information is not complete, move the end point of the present segment toward a next segment to determine an end point of the information, and use the end point of the information as the end point of the present segment and a start point of the next segment.

16. The electronic device according to claim 10, wherein the processor is further configured to:
judge whether information of an end point of a present segment is complete and, if the information is not complete, move the end point of the present segment toward a start point of the present segment to determine a start point of the information, and using the start point of the information as the end point of the present segment and a start point of a next segment.

17. The electronic device according to claim 10, wherein the processor is further configured to:
judge whether layout atom data contained in the layout data is used within a preset time period and, if the layout atom data is not used within the preset time period, delete the layout atom data.

18. The electronic device according to claim 10, wherein the processor is further configured to:
judge whether a memory space occupied by layout atom data contained in the layout data is greater than a preset value and, if the occupied memory space is greater than the preset value, delete the layout atom data.

19. A non-transitory readable storage medium including instructions that, when executed by a processor of a terminal, cause the terminal to perform a method for processing an e-book document, the method comprising:
obtaining an e-book document;
dividing content of the e-book document into a plurality of segments in accordance with a preset segmentation manner;
composing the plurality of segments into an ordered segment group;
selecting one segment from the segment group as a current segment;
parsing the content of the current segment to generate layout data; and
generating a page image in accordance with the layout data.
